(19) United States
(12) Patent Application Publication
(10) Pub. No.: US 2026/0028074 A1
(43) Pub. Date: Jan. 29, 2026

(54) DRAG WHEEL TO ASSEMBLIES FOR OFF-ROAD VEHICLES

(71) Applicant: Russell McConahay, Salem, UT (US)

(72) Inventor: Russell McConahay, Salem, UT (US)

(21) Appl. No.: 19/221,317

(22) Filed: May 28, 2025

Related U.S. Application Data
(60) Provisional application No. 63/674,602, filed on Jul. 23, 2024.

(51) Int. Cl. B62D 61/12; B60D 1/18; B60D 1/52; B60D 1/60

(52) U.S. Cl. CPC B62D 61/12; B60D 1/187; B60D 1/52; B60D 1/60

(57) ABSTRACT

Apparatus, systems and methods for detachable drag wheel assemblies for off-road vehicles that provide protection by facilitating passing across obstacles that could strike the rear of vehicle, while providing a simple attachment point for towing. In one illustrative embodiment, a wheel may be rotatably disposed in a housing, with the wheel extending through an open rear portion and an open bottom of the housing. A post may extend forward from the housing for placement in a receiver hitch on an off-road vehicle, with the post and housing configured to extend to or past the rear of the off-road vehicle when secured in the receiver hitch. A tow rope connector may be disposed on an upper surface of the housing and include a body portion with a rounded cross-section with a concave exterior sidewall and an upper cap extending past the sidewall.

### CROSS-REFERENCE TO RELATED APPLICATION

This application claims the benefit of U.S. Provisional Application No. 63/674,602, filed Jul. 23, 2024, the disclosure of which is incorporated herein by reference in its entirety.

### TECHNICAL FIELD

The present invention relates to devices and systems for protecting and using off road vehicles.

### BACKGROUND

When off-road vehicles are used for negotiating paths that include obstructions, including shelves or drop-offs, a known problem is that as the rear wheels move past the obstruction, the rear portion of the vehicle can come into contact with the obstruction. This contact can occur as an abrupt drop into the obstruction that causes damage to the rear of the vehicle. While most off-road vehicles have integral skid plates to protect undercarriage components, these do not prevent damage to the rear bumper, a rear mounted tire, or a rear mounted receiver hitch. One attempt to address this has been the use of hitch sliders that insert into a receiver hitch and have a ramped surface that serves as a slide surface to protect the receiver hitch. While these can provide some protection, the slide action abrades both the slider and the obstruction, which can cause damage to the trail and may not be able to easily pass over some obstacles. Additionally, they can slow down the ability to traverse and may prevent the vehicle from being used for towing when inserted.

An apparatus, system, or method that provided protection for the rear of the vehicle while facilitating off road travel would be an improvement in the art. Such an apparatus or system that provided additional functionality would be a further improvement in the art.

### SUMMARY

The present disclosure is directed to apparatus, systems and methods for providing a detachable drag wheel assembly that extends past the rear of an off-road vehicle to provide protection by facilitating passing across obstacles that contact the rear of vehicle, while providing a simple attachment point for towing to assist other off-road vehicles. In one illustrative embodiment, a wheel may be rotatably disposed in a housing, with the wheel extending through an open rear portion and an open bottom of the housing. A post may extend forward from the housing for placement in a receiver hitch on an off-road vehicle, with the post and housing configured to extend past the rear of the off-road vehicle when secured in the receiver hitch. A tow rope connector point may be disposed on an upper surface of the housing. In some illustrative embodiments, the tow rope connector may include a body portion with a rounded cross-section with a concave exterior sidewall. An upper cap may be disposed above the body portion, extending past the sidewall. An upper surface of the cap may serve as a step.

### DESCRIPTION OF THE DRAWINGS

It will be appreciated by those of ordinary skill in the art that the various drawings are for illustrative purposes only. The nature of the present invention, as well as other embodiments of the present invention, may be more clearly understood by reference to the following detailed description of the invention, to the appended claims, and to the several drawings.

FIGS. 1, 2, and 3 are rear perspective, front perspective, and bottom views of a first illustrative embodiment of a drag wheel assembly for an off-road vehicle in accordance with the principles of the present disclosure.

FIG. 4 is an exploded view of the components of the embodiment of FIGS. 1-3.

FIG. 5 is a side view of a second illustrative embodiment of a drag wheel assembly for an off-road vehicle in accordance with the principles of the present disclosure installed in a receiver hitch on an offroad vehicle.

FIG. 6 is a side perspective view of the embodiment of FIG. 5 with a tow rope placed in position thereon for use.

FIG. 7 is a top perspective view of a portion of the assembly of FIGS. 5 and 6.

### DETAILED DESCRIPTION

The present disclosure relates to apparatus, systems and methods for drag wheel assemblies for off-road vehicles. It will be appreciated by those skilled in the art that the embodiments herein described, while illustrating certain embodiments, are not intended to so limit this disclosure or the scope of the appended claims. Those skilled in the art will also understand that various combinations or modifications of the embodiments presented herein can be made without departing from the scope of this disclosure. All such alternate embodiments are within the scope of the present disclosure.

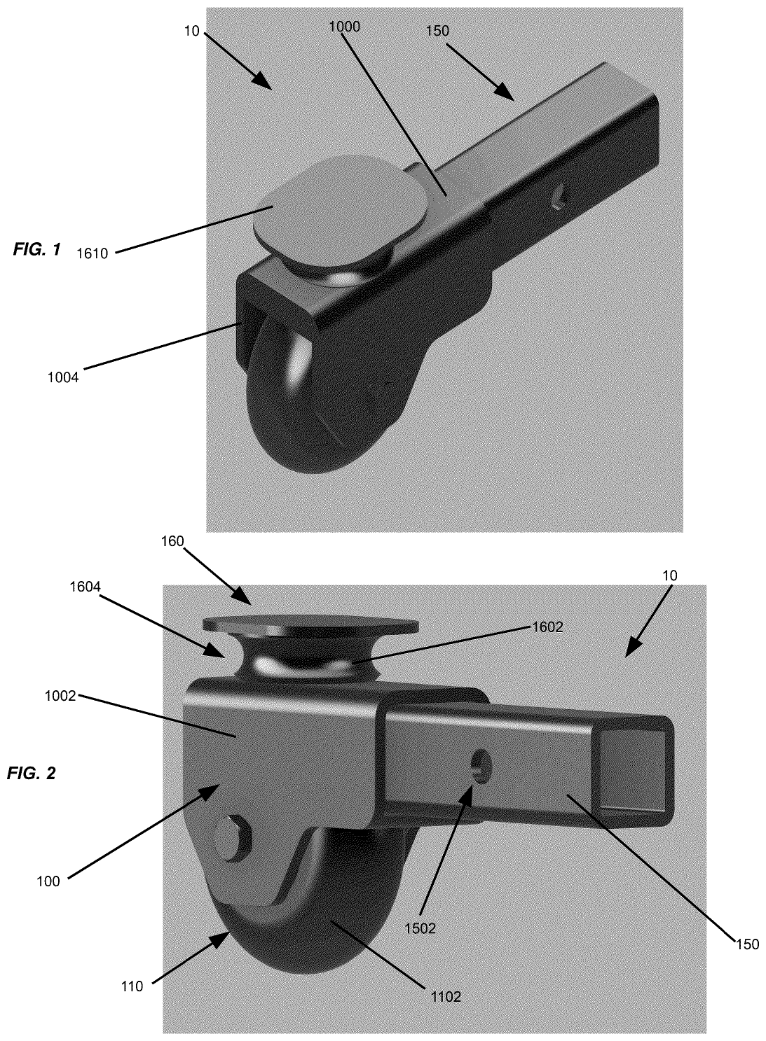

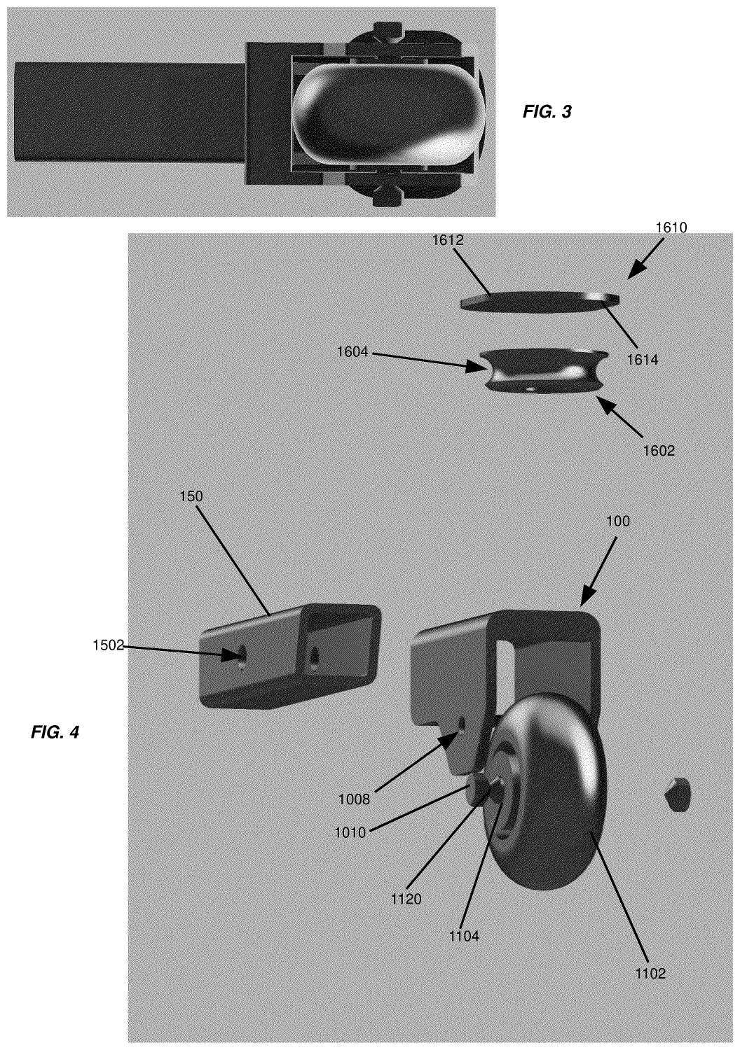

Referring to FIGS. 1 through 4, a first illustrative embodiment of a drag wheel assembly 10 is depicted. A central housing 100 may be formed as a generally U-shaped member having a generally planar top and two downwardly extending sides 1002 and 1004 which define the U shape. As depicted, each of the sides, 1002 and 1004, may include a generally rectangular forward portion and a rearward extended tab that extends downwards to define a wheel attachment point. In the depicted embodiment, the wheel attachment points may be aligned holes that are configured to serve as the seat for an axle pin 1120, one of which is indicated at 1008.

A wheel assembly 110 may be rotatably disposed in the housing 100. As depicted, the wheel assembly may include a wheel, which may be a polymer wheel 1102 disposed on a core 1104 that may include a suitable bearing. It will be appreciated that by using a polymer wheel, that the wheel may have a better ability to absorb shock from striking an obstacle and may be less damaging to such an obstacle when passing thereover, in comparison to a solid metal wheel. An axle pin 1120 may extend through the wheel assembly and wheel attachment holes 1008. As depicted, suitable fasteners 1010 may be used to secure the axle pin 1120 in the seat. As depicted, the wheel 110 may extend through the open rear portion and the open bottom of the housing 100. By placing the wheel in middle of the housing, the axle pin is supported at each end, allowing the opposite sides of the housing to protect the core of the wheel assembly and to reinforce the connection and the wheel assembly.

A post 150 may extend forward from the housing 100. As depicted, the housing and post may be formed as separate members that are joined together but it will be appreciated that in some embodiments, they be formed as an integral unit. Additionally, while depicted as a hollow tube, the post 150 may be a solid member. As depicted, the post 150 may be configured for placement in a receiver hitch on an off-road vehicle. The post 150 may thus have a cross-sectional rectangular or square shape for a standard receiver hitch or vary for other receivers. As depicted, the post 150 may include connection holes 1502 passing therethrough allowing a pin to be inserted therein for securing in a receiver. In some embodiments, multiple connection holes may be present allowing the length of the post extending from the receiver to be selectably varied. It will be appreciated that other connection methods for differing receivers may be used. For example, where a solid member post is used, a connection hole passing though the post could be threaded for the placement of a threaded fastener.

A tow rope connector 160 may be disposed on an upper surface of the housing 100. In the depicted embodiment, the tow rope connector 160 may include a body portion 1602. As depicted, this may be a body having a rounded cross-section with a concave exterior sidewall defining a channel 1604 that surrounds the body 1602. In some embodiments, the body of a pulley could be adapted for use as the body.

An upper cap 1610, which may be a planar member with an upper surface 1612 and an opposite lower surface 1614 may be disposed above the body portion, extending past the sidewall. The upper surface 1612 of the upper cap 1610 may serve as a step and in some embodiments may have a non-slip textured surface as depicted in FIG. 7. Suitable textures may include the depicted cross-hatching, diamond plate or the like. In some alternate embodiments, the upper cap 1610 may have a smooth surface or may have a textured material, such as grip tape, attached thereto with a suitable adhesive.

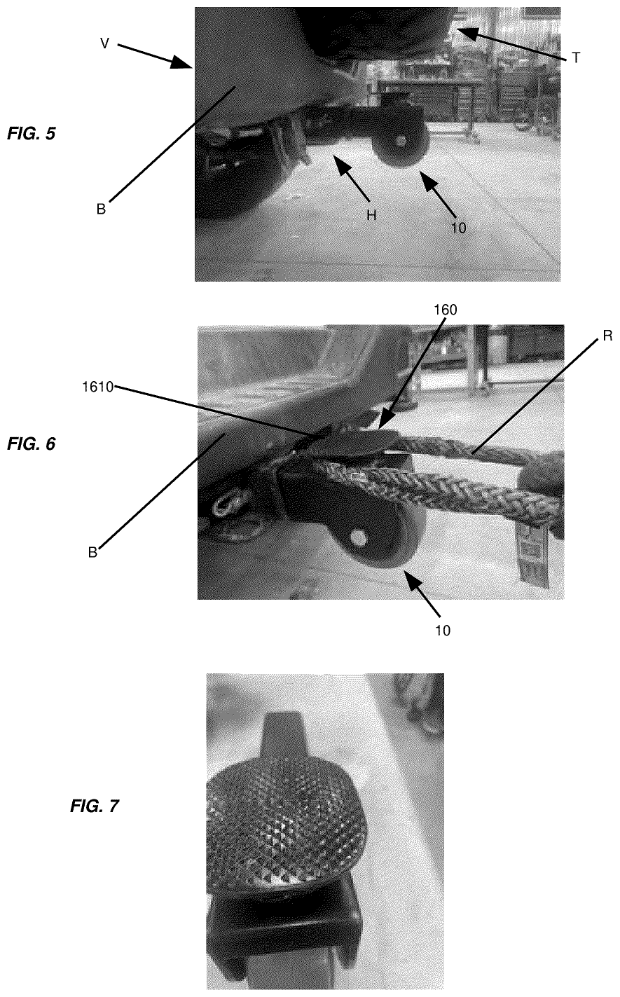

Turning to FIG. 5, a drag wheel assembly 10 is depicted installed in the tube of a receiver hitch H of an off-road vehicle V. As depicted, the drag wheel assembly 10 preferably extends to a point even with or past the rear of the structural portions of the off-road vehicle V. This allows the assembly to provide protection by facilitating passing across obstacles that would otherwise contact the rear of vehicle. In use, when the wheels of the vehicle V have passed over an obstruction that acts as a shelf or other drop, rather than contact the bumper B or mounted spare tire T of the vehicle V, the obstacle contacts the wheel assembly. Unlike a hitch slider which abrades against the surface of the obstacle, the wheel assembly rotates on the axle thereby allowing the vehicle to roll forward and downwards over the obstacle. The present disclosure includes methods of using the drag wheel assembly mounted in the vehicle to pass over obstacles in a manner where the obstacles contact the wheel assembly rather than the vehicle.

FIG. 6 depicts the drag wheel assembly 10 with the loop end of a tow rope or a recovery strap R placed on the tow rope connection point for use in a towing. As depicted, the loop end is placed over the cap 1610. The rope or strap then resides in the channel 1604 of body 1602. Cap 1610 extending past the body 1602 helps to prevent the tow rope from slipping off of the body 1602 during use. This allows the vehicle V to be used to tow other vehicles, as in an off-road rescue situation without the need to remove the assembly from the receiver as the assembly provides a simple attachment point for towing to assist other off-road vehicles.

It will be appreciated that the various components for an assembly can be constructed from suitable materials having the requisite strength and durability to allow them to function, including steel and other metal alloys and suitable polymeric materials. Components may be assembled and attached in any suitable manner, including welding. It will be appreciated that the portions of the assembly discussed herein may be formed as separate members that are joined together, or as one or more integrated units that may be joined together.

While this disclosure has used certain embodiments for description, it will be appreciated these are exemplary and that the teaching herein can be further modified with the spirit and scope of this disclosure. This application is therefore intended to cover any variations, uses, or adaptations of the disclosure using its general principles. Further, this application is intended to cover such departures from the present disclosure as come within known or customary practices in the art to which this invention pertains and which fall within the limits of the appended claims.

What is claimed is:

1. A detachable drag wheel assembly for an off-road vehicle, comprising:
a housing with an upper surface, an open rear portion and an open lower portion;
a wheel rotatably disposed in the housing, with the wheel extending through the open rear portion and the open bottom;
a post extending forward from the housing, the post configured for detachable attachment in a receiver hitch on an off-road vehicle;
a tow rope connection member on the upper surface of the housing, the tow rope connection member comprising a body portion having an exterior sidewall and an upper cap extending past the sidewall.

2. The detachable drag wheel assembly of claim 1, wherein the body portion of the tow rope connection member has a rounded cross-sectional shape.

3. The detachable drag wheel assembly of claim 1, wherein the body portion of the tow rope connection member has a concave exterior sidewall.

4. The detachable drag wheel assembly of claim 1, wherein the upper cap of the tow rope connection member has an upper surface with a non-slip textured surface.

5. The detachable drag wheel assembly of claim 4, wherein the upper cap of the tow rope connection member has a textured surface comprising a pattern formed in the upper surface.

6. The detachable drag wheel assembly of claim 1, wherein the post and housing are configured to extend such that the wheel is past the rear of an off-road vehicle when secured in a receiver hitch on the off-road vehicle.

7. The detachable drag wheel assembly of claim 1, wherein the housing is generally U-shaped.

8. The detachable drag wheel assembly of claim 7, wherein the wheel is secured in the housing between the upper surface and two opposite downwardly extending side members.

9. The detachable drag wheel assembly of claim 8, further comprising an axle extending through the wheel and secured in two opposite attachment ports disposed on the opposite downwardly extending side members.

10. The detachable drag wheel assembly of claim 1, wherein the wheel comprises a polymer outer portion disposed on an inner core.

11. The detachable drag wheel assembly of claim 10, comprising a bearing assembly disposed in the inner core.

12. A detachable drag wheel assembly for an off-road vehicle, comprising:
a body with an upper member, and two opposite downwardly extending members defining an open rear portion and an open lower portion;
a wheel assembly rotatably attached to the body, with at least a portion of the wheel extending through the open rear portion and the open bottom;
a hitch post extending forward from the body, the hitch post configured for detachable attachment in a receiver hitch on an off-road vehicle;
a tow rope connection member on the upper member, the tow rope connection member comprising a connection body having an exterior sidewall and an upper cap disposed on the connection body that extends past the sidewall.

13. The detachable drag wheel assembly of claim 12, wherein the connection portion of the tow rope connection member has a rounded cross-sectional shape.

14. The detachable drag wheel assembly of claim 12, wherein the body portion of the tow rope connection member has a concave exterior sidewall.

15. The detachable drag wheel assembly of claim 12, wherein the upper cap of the tow rope connection member has an upper surface with a non-slip textured surface.

16. The detachable drag wheel assembly of claim 15, wherein the upper cap of the tow rope connection member has a textured surface comprising a pattern formed in the upper surface.

17. The detachable drag wheel assembly of claim 12, wherein the post and housing are configured to extend such that the wheel assembly is accessible past the rear of an off-road vehicle when secured in a receiver hitch on the off-road vehicle.

18. The detachable drag wheel assembly of claim 12, wherein the wheel assembly comprising an axle extending through a central body, and the axle is secured on opposite ends to the opposite downwardly extending side members.

19. The detachable drag wheel assembly of claim 18, wherein the wheel comprises a polymer outer portion disposed on the central body.

20. The detachable drag wheel assembly of claim 19, wherein the wheel assembly includes a bearing disposed in the central body.
